(19) United States
(12) Patent Application Publication
(10) Pub. No.: US 2014/0265934 A1
(43) Pub. Date: Sep. 18, 2014

(54) VEHICLE INTERIOR LIGHTING

(71) Applicant: Federal-Mogul Corporation, Southfield, MI (US)

(72) Inventor: David Edward Ramey, Grand Blanc, MI (US)

(21) Appl. No.: 14/210,603

(22) Filed: Mar. 14, 2014

Related U.S. Application Data
(60) Provisional application No. 61/788,844, filed on Mar. 15, 2013.

(51) Int. Cl. B60Q 3/02; B60Q 3/00

(52) U.S. Cl. CPC B60Q 3/02; B60Q 3/001; B60Q 3/0293
USPC 315/307; 362/488

(57) ABSTRACT

A lighting system and method for a vehicle interior wherein the light system includes an electronic control unit (ECU) and a lighting layer having a plurality of light elements and a proximity sensing system. The lighting layer is coupled to the ECU and each of at least some of the light elements may be independently turned ON or OFF in response to a first proximity pattern provided by human interaction and received by the proximity sensing system. The lighting arrangement permits an occupant of the vehicle to selectively define the area and/or shape of local illumination and to control one or more characteristics of the illumination such as color or brightness.

### CROSS-REFERENCE TO RELATED APPLICATION

This application claims the benefit of U.S. Provisional Application No. 61/788,844, filed Mar. 15, 2013, the entire contents of which are hereby incorporated by reference.

### TECHNICAL FIELD

The present invention relates to vehicle lighting, and more specifically, to lighting the interior of the vehicle using proximity sensing devices.

### BACKGROUND

Vehicle interior lighting is typically in passenger cars and other vehicles to provide task lighting, general illumination, and/or mood or scene lighting. Traditional incandescent bulb-based lighting has more recently been replaced or supplemented in many applications by newer technologies including discrete LEDs and distributed lighting components. Other modern technologies have been proposed or used as well. For example, U.S. Pat. No. 6,464,381 discloses a touch control electroluminescent panel located in a vehicle headliner that has brightness control. The panel may be located above the compartment-side fabric of the headliner. And U.S. Pat. No. 7,677,774 discloses a touch sensitive light for a vehicle interior having an illumination surface and multiple bulbs, the illumination surface having a matrix of electrodes which provide control over the bulbs when a user swipes a finger over the surface. This swiping action may be used to switch on or off lighting at different regions of the illumination surface and/or to couple or decouple light operation to a door switch.

While such technologies permit overhead lighting to be controlled to some extent, they may be somewhat limited in their flexibility for providing desired illumination at different locations within the vehicle.

### SUMMARY

In accordance with one aspect of the invention, there is provided a lighting system for a vehicle interior wherein the light system includes an electronic control unit (ECU) and a lighting layer having a plurality of light elements and a proximity sensing system. The lighting layer is coupled to the ECU and each of at least some of the light elements may be independently turned ON or OFF in response to a first proximity pattern provided by human interaction and received by the proximity sensing system. In at least some embodiments, this lighting arrangement may advantageously be used by an occupant of the vehicle to selectively define the area and/or shape of local illumination, thereby improving the customer experience.

Embodiments of this lighting system may include one or more of the following features, in any technical feasible combination.
Lighting characteristics of the light elements may be configurable in response to a second proximity pattern. The first and second proximity patterns may be the same or different, and the lighting characteristic may be brightness, color, or some other characteristic of the emitted light.
The proximity sensing system may be responsive to contact of human skin.
The one or more light elements may be grouped into at least one sector, and the first proximity pattern may illuminate all the light elements within the at least one lighting sector when any portion of the proximity pattern includes a proximity input to the at least one lighting sector.
The lighting layer may be configurable to enable a user to define a lighting sector that may include a plurality of the light elements.
The first proximity pattern may define an at least partially closed path, and a plurality of light elements bounded by the path may then be illuminated when the light elements on the path are illuminated.

In accordance with another aspect of the invention, there is provided a method of illuminating the interior of a vehicle, including the steps of: detecting a first proximity input at a lighting layer of a vehicle having a proximity sensing system, and illuminating at least a portion of the lighting layer based on the first input, wherein the lighting layer comprises a plurality light elements that may be independently actuated. The method may be carried out using the lighting system defined above, or using other suitable lighting component.

Embodiments of this method may include one or more of the following features, in any technical feasible combination.
The portion of the lighting layer may include a plurality of light elements grouped in at least one of a pre-configured sector or a user-defined sector.
The user-defined sector may include one of a closed path or a partially closed path defined by the first input, and the light elements located on the closed or partially closed path may be illuminated. Additionally or alternatively, the light elements bounded by the closed path may be automatically illuminated.
Where a partially closed path is defined, the method may include the step of automatically closing the partially closed path by illuminating light elements between the endpoints of the partially closed. Light elements bounded by the newly closed path may be automatically illuminated in some embodiments.
The method may include the step of detecting a second proximity input at the lighting layer and altering at least one characteristic of the emitted light based on the second input, and the lighting characteristic may be brightness, color, or some other characteristic of the emitted light.
Where the second input is received at a portion of the light elements of an illuminated sector, the at least one characteristic may be automatically altered for the entire sector.

### BRIEF DESCRIPTION OF THE DRAWINGS

One or more embodiments of the invention will hereinafter be described in conjunction with the appended drawings, wherein like designations denote like elements, and wherein:

FIG. 1 is a schematic diagram depicting a vehicle having an interior lighting system;

FIG. 2 is a cross-sectional view along section lines 2-2;

FIG. 3 is a bottom view of a vehicle roof from within the vehicle's interior space;

FIG. 4 is an exemplary vehicle touchscreen display illustrating a manual controller implemented in software;

FIG. 5 is a view as in FIG. 3 illustrating various examples of an illuminated user-selected light element configurations in a vehicle headliner; and

FIG. 6 is a flowchart illustrating one exemplary method of using the system shown in FIG. 1.

### DETAILED DESCRIPTION OF THE ILLUSTRATED EMBODIMENT(S)

The system and method described below pertains to a vehicle lighting system. More specifically, the lighting system is directed to the interior of the vehicle and is configurable by the vehicle occupant(s). In one embodiment described herein, the user (occupant) may illuminate regions of the vehicle headliner by touch and additionally configure lighting characteristics such as color and brightness.

FIG. 1 illustrates a vehicle 100 having an interior lighting system 110. The lighting system includes a vehicle headliner assembly 120, supporting electronic circuitry 170, an electronic control unit (ECU) 180, and in some implementations, a manual controller 190.

The interior lighting system may be implemented anywhere within the vehicle 100; thus, it will be appreciated that the implementation in the vehicle headliner 120 is merely exemplary. As shown in FIG. 2, the headliner 120 may have multiple layers including: a substrate layer 122 coupled to the vehicle ceiling 124 (e.g., a sheet metal layer or interior roof framing), an optional foam layer 126, a lighting layer 130, and an optional decorative layer 132. The substrate layer 122 may be molded to fit the vehicle ceiling 124 and may provide mounting appurtenances for the other layers 126, 130, 132, and the substrate and foam layers may provide sound and temperature insulation, the construction and use of which are known to skilled artisans.

The lighting layer 130 may include a proximity sensing system or layer 140 and a light source 142 having one or more light elements 144. The sensing system 140 may be responsive to the proximity, contact, and/or touch of an object, such as a human hand. The sensing system 140 may utilize various technologies including: resistive touch sensing, capacitive touch sensing, projected capacitance sensing, infrared grid sensing, infrared acrylic projection sensing, optical imaging sensing, dispersive signal sensing, acoustic pulse recognition sensing, just to name a few. The proximity sensing system may be located below the light elements or above or may be integrated therewith. Other proximity sensing systems 140 may be used, as will be appreciated by skilled artisans.

The light source 142 may be any device for providing light, including light visible to the human eye or otherwise. FIG. 3 illustrates one embodiment of the light source 142 having multiple light elements 144; however, the light source 142 may have a single light element (e.g., a thin film light element). The light elements 144 may be controllable or configurable to emit variable brightness intensities, variable colors, or both. In addition, groups of adjacent light elements 144 are shown as clustered together in multiple lighting sectors or pre-configured lighting sectors 146. Here, the lighting sectors are shown as rectangular arrays; however, other arrangements are possible—e.g., the sectors 146 may be oval, circular, linear, etc. In addition, sectors 146 may define multiple groups of one or more light elements and these groups may include non-adjacent light elements. In FIG. 3, some of the light elements are illustrated as illuminated while others are not; in this example, light sectors 146a are shown as illuminated whereas light sectors 146b are not. Examples of light elements include incandescent light elements, fluorescent light elements, halogen light elements, light-emitting diode (LED) light elements, high-intensity discharge (HID) light elements, and any other suitable lighting technology. Thus, for example, the lighting layer may have various arrangements such as an array of LEDs or various combinations of different types of light elements (e.g., LEDs, fluorescent, incandescent, etc.).

The light layer 130 may be coupled to and provided power via the supporting electronic circuitry 170. In addition, some aspects light element 144 control (i.e., individually and/or according to sector(s) 146) may be supported via the circuitry 170.

The circuitry 170 may be coupled to the ECU 180. The ECU may also provide power and/or control to the light layer including individual or sector power and/or control of the light elements 144. The ECU 180 may include one or more processors 182 (e.g., processing units, controllers, microprocessors, micro-controllers, discrete logic circuit(s)) having logic gates for implementing logic functions on data signals, application specific integrated circuits (ASIC) with suitable logic gates, complex programmable logic devices (CPLD), programmable or field-programmable gate arrays (PGA/FPGA), and/or the like. In addition, the ECU may have one or more memory devices or computer readable media 184 operatively coupled to the processor(s) 182.

And lastly, the ECU 180 may be coupled to the optional manual controller 190. The controller 190 may be any in-vehicle device or remote user interface having actuatable hard or soft switches to provide manual override or manual control of the lighting layer 130. In one exemplary embodiment, the controller 190 is illustrated as a touch-screen interface having soft switches and a drop-down menu (FIG. 4). It may have power control 192 (e.g., power override), color control 194, brightness control 196, and regional or sector control 198, just to name a few examples.

The afore-described lighting system 110 may be utilized to provide interior ambient or mood lighting, utility lighting (such as map or reading lighting), entertainment lighting, just to name a few. In at least one implementation, the user of the lighting system 110 may control or configure the lighting system by performing a proximity pattern (and the pattern may include one or more proximity actions). The processor 182 in the ECU 180 may be programmed to control the light source 142 based on input (e.g., including various proximity patterns) received from the proximity sensing system 140 via the circuitry 170.

Performing a proximity pattern may include the user placing his (or her) hand in proximity of the lighting source 142 and selecting one or more lighting sectors 146, one or more light elements 144, or both. For example, the user's finger(s) or hand may be used to tap, swipe or drag, hover, touch and hold, single-touch, double-touch, triple-touch, etc. one or more of the lighting sectors 146 and illuminate the light elements 144 in those sector(s) (i.e., turn them ON). And for example, the user's finger(s) or hand may then re-tap, re-touch, re-swipe, etc. the same lighting sectors 146 or light elements 144 to control various characteristics of the emitted light such as brightness or intensity, color or wavelength, etc. Proximity patterns may also be used to turn the lighting sectors 146 OFF (or ON again). It should be appreciated that where multiple lighting sectors 146 are ON, the power to or emitted light characteristics from the sectors may be altered individually or independently of other lighting sectors 146 that are ON. In addition, when sectors 146 are turned OFF, the configuration of the lighting sectors 146 or light elements 144 may be stored in the memory 184 of the ECU 180. And when they are turned on again, they may emit light according to the stored configuration without repeating the previous proximity pattern.

In one embodiment shown in FIG. 5, the user may perform a first proximity pattern selecting one or more lighting sectors or light elements in a first loop or path (e.g., a user-defined sector 148)—turning their selection ON, and upon performing the first proximity pattern, any sectors or elements within the loop or bounded thereby that were OFF may also be turned ON. Or for example, the system 110 may operate to automatically close an unclosed (or open) path traced by the user, and then, as part of the proximity pattern, the user may elect to illuminate all of the light elements with the automatically closed path. Alternatively, after the system automatically closes the unclosed path, the system may automatically illuminate all the light elements therein. The user-defined loops, paths, sectors, boundaries, etc. enable the user to customize or configure the overhead light source. In addition, this loop or path method may be used to control or configure the emitted light characteristics as well. For example, the user may perform a second proximity pattern that includes a second loop to change a light characteristic (e.g., color or brightness)—and the second loop and the sectors 146 or elements 144 within the second loop may all change color. In some implementations, the first loop and the second loop may be the same loop. In addition, some proximity patterns may actuate alter brightness and color coincidentally.

Again in FIG. 5, some of the light elements are illustrated as illuminated while others are not; in this example, some of the user-defined light sectors 148 are a closed and filled path 150 and other user-defined light sectors 148 are closed and unfilled paths 152. In addition, while a loop is described above, other shapes may be used. Furthermore, the term loop may include a curved line, one or more angular lines, or combinations of both.

In other embodiments, the light characteristics of portions of the sector(s) 146 or groupings of the light elements 144 (user-defined or otherwise) that are ON may be altered independent of the other portions or groupings—including changing the light characteristics (e.g., color or brightness) of the sector(s) 146 or groupings within the loop while not altering the light characteristics of the loop itself. Thus, the system may provide the ability of the user to selectively alter the color, brightness, etc. of some light elements relative to others. It should be appreciated that the number of configurations of the light source 142 can be numerous (e.g., depending on the number of sectors 146, the number of light elements 144, the number of brightness gradations, the number of selectable colors, etc.), and that all such possible configurations are contemplated herewith although they may not be explicitly described. Similarly, the quantity of proximity patterns can be numerous (as the number of combinations of a user's hand touching, hovering, tapping, multiple-tapping, swiping, moving quickly, moving slowly, holding, etc. are numerous).

The afore-described method pertained to the vehicle headliner 120; however, it should also be appreciated that the headliner is merely one example. Other regions of the vehicle 100 may also have a light source 142 such as the vehicle pillars, doors, dashboard, etc. (for example, FIGS. 3 and 5 illustrate some light elements 144 on the A, B, C, and D pillars).

While the lighting sector(s) and/or light elements 144 may be controlled by a user via the proximity sensing system 140, the sectors and elements may also be controlled using the manual controller 190. In some instances, the manual controller may serve as an override—enabling the operator to override any proximity controlled actions.

FIG. 6 illustrates one example of a method 600 of using the present system 110. The method begins at step 610 where the lighting layer 130 may receive or detect an input. At step 620, the system may identify whether the input is a proximity pattern. If it is not, the system may standby awaiting to detect another input at step 610; however, if the input is a proximity pattern, the method may proceed to step 630. At step 630, the system 110 may determine or classify the type of proximity pattern; e.g., the ECU 180 may determine based upon the input what power and/or control is to be exercised over the lighting system 110. Upon classifying the proximity pattern, the method may proceed to steps 640 or 650. If the proximity pattern included illumination of at least a portion of the lighting layer 130, at step 640 the one or more like elements 144 may be illuminated, and the method may proceed to step 660. However if the proximity pattern included turning off at least a portion of the lighting layer or de-illuminating, at step 650 de-illumination may be performed, and the method thereafter may proceed to standby again awaiting to detect another input at step 610.

At step 660, the system may determine whether the proximity pattern included a change to at least one characteristic of the emitted light. If the proximity pattern did include this change, the one or more characteristics may be altered at step 670. However if the pattern did not include this change, the system may standby again awaiting to detect another input at step 610. In some instances, the classification of the proximity pattern at step 630 may not include illumination or de-illumination, and the method may bypass steps 640, 650 and proceed directly to step 660. These instances include receiving a proximity input that indicates only a change in the light characteristics; e.g., of light elements that may already be illuminated.

It should be appreciated that the method 600 is merely exemplary and that other embodiments exist. For example, the classification at step 630 may determine a proximity pattern that both illuminates a portion of the lighting layer and de-illuminates another portion.

The system and the method described herein may provide the user with the ability to customize the interior lighting within the vehicle. The actuation of the lighting layer by proximity of the user's hand (such as by touch) may provide uniquely configured lighting arrangements as well as provide entertainment to the occupants of the vehicle.

The system and the method described above or parts thereof may be implemented using a computer program product may include instructions carried on a computer readable medium for use by one or more processors of one or more computers (e.g., within the ECU 180) to implement one or more of the method steps. The computer program product may include one or more software programs (or applications) comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media 184, which can include one or more storage devices, articles of manufacture, or the like. Exemplary computer readable media include computer system memory 184, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of executing instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A lighting system for a vehicle interior, comprising:
an electronic control unit (ECU); and
a lighting layer having a plurality of light elements and a proximity sensing system, wherein the lighting layer is coupled to the ECU,
wherein each of at least some of the light elements may be independently turned ON or OFF in response to a first proximity pattern provided by human interaction and received by the proximity sensing system.

2. The lighting system of claim 1 wherein lighting characteristics of the light elements are configurable in response to a second proximity pattern.

3. The lighting system of claim 2 wherein the first proximity pattern is the same as the second proximity pattern.

4. The lighting system of claim 2 wherein the characteristics include brightness and color.

5. The lighting system of claim 1 wherein the proximity sensing system is responsive to contact of human skin.

6. The lighting system of claim 1 wherein the one or more light elements are grouped into at least one sector, wherein the first proximity pattern illuminates all the light elements within the at least one lighting sector when any portion of the proximity pattern includes a proximity input to the at least one lighting sector.

7. The lighting system of claim 1 wherein the lighting layer is configurable to enable a user to define a lighting sector, wherein the lighting sector includes a plurality of the light elements.

8. The lighting system of claim 1 wherein the first proximity pattern defines an at least partially closed path, wherein a plurality of light elements bounded by the path is illuminated when the light elements on the path are illuminated.

9. A method of illuminating the interior of a vehicle, comprising the steps of:
detecting a first proximity input at a lighting layer of a vehicle having a proximity sensing system; and
illuminating at least a portion of the lighting layer based on the first input,
wherein the lighting layer comprises a plurality light elements that may be independently actuated.

10. The method of claim 9, wherein the portion of the lighting layer includes a plurality of light elements grouped in at least one of a pre-configured sector or a user-defined sector.

11. The method of claim 10, wherein the user-defined sector includes one of a closed path or a partially closed path defined by the first input, wherein the light elements located on the closed or partially closed path are illuminated.

12. The method of claim 11 further comprising the step of automatically illuminating the light elements bounded by the closed path.

13. The method of claim 11 further comprising the step of automatically closing the partially closed path by illuminating light elements and automatically illuminating the light elements bounded by the newly closed path.

14. The method of claim 9 further comprising detecting a second proximity input at the lighting layer and altering at least one characteristic of the emitted light based on the second input, wherein the at least one characteristic includes brightness and color.

15. The method of claim 14, wherein the second input is received at a portion of the light elements of an illuminated sector, wherein the at least one characteristic is automatically altered for the entire sector.
